(19) United States
(12) Patent Application Publication
(10) Pub. No.: US 2007/0255492 A1
(43) Pub. Date: Nov. 1, 2007

(54) Method for Enabling Useful Data, in Particular Navigation Data

(76) Inventor: Holger Listle, Hildesheim (DE)

Correspondence Address: KENYON & KENYON LLP, ONE BROADWAY, NEW YORK, NY, 10004, US

(21) Appl. No.: 10/590,873

(22) PCT Filed: Jan. 7, 2005
(86) PCT No.: PCT/EP05/50058

§ 371 Date: Jun. 8, 2007

(30) Foreign Application Priority Data
Feb. 26, 2004 (DE) 10 2004 009 276.1

(51) Int. Cl. G01C 21/00

(52) U.S. Cl. 701/207

(57) ABSTRACT

A method for enabling useful data, in particular navigation data, which are stored on a data carrier or transmitted into a data processing system. The user is provided with an optimized data provision method. For this purpose, the data are enabled for an area that is freely selectable by the user of the useful data.

### FIELD OF THE INVENTION

The present invention relates to a method for enabling useful data, in particular navigation data, which are stored on a data carrier or transmitted into a data processing system.

### BACKGROUND INFORMATION

Navigation systems which have large-capacity data carriers are known from the related art. Such navigation systems are available with a functionality which allows selective and/or time-limited enabling of navigation data. The C-IQ system from VDO is such a system.

A disadvantage of this system is that enabling is possible only within political boundaries, i.e., only within a country or continent. At least two countries or an entire continent must be enabled to cross-border commuters to make the needed navigation data available in the area which is relevant to them.

An object of the present invention is to provide a method which allows a customer-oriented provision of user data.

### SUMMARY OF THE INVENTION

According to the present invention, the object is achieved in that the useful data, in particular navigation data, which are stored on a data carrier or transmitted into a data processing system, is enabled for an area which is freely selectable by the user of the useful data. This method is suited in particular for navigation systems in vehicles.

### DETAILED DESCRIPTION

Receipt of the navigation data by the user in the form of map data, additional information about the corresponding area, event information, or other spatially assignable data for an area which is freely selectable by the user eliminates an orientation according to political boundaries, which are becoming increasingly less important, thereby allowing the data user to freely travel in a preferred area or an area frequently traveled in.

If the intra-device license management is supplemented by the described geometric consideration, it is possible to enable a defined radius around a position as a data area. This radius is not limited to any political hierarchies within a data set, which is regarded as the content of a data carrier for the selected area.

In addition to a circular definition around a central point and radius information, it is possible to define an area for which the useful data is required by defining specific corner points. Corresponding licensing fees arise as a function of the size of the selected area.

One refinement of the present invention provides that the use authorization is transmitted via a radio signal or is present on the data carrier. If the data user purchases a data carrier, only the area of interest to the user is taken into consideration; alternatively, the instantaneous position of the user is determined with the aid of a navigation system and enabling is authorized, depending on whether there is a license for the area of interest. If the user is not located within the user-defined area, the functionality of the system is restricted, or the data are not enabled.

If the useful data or navigation data are transmitted via a radio signal, the use authorization may likewise be transmitted via a radio signal, the position of the user being simultaneously checked either by use of GPS data or by radiolocation.

The use authorization may also be present in encoded form on a data carrier, or stored in a navigation device. If navigation within the defined area is intended, the data are enabled. If the navigation involves areas outside the defined area, an error message may be generated or the navigation may be terminated, for example.

Furthermore, the useful data or navigation data are enabled in a time-limited manner, thereby affording a particularly economical variant for the data user. Instead of spending a great amount of money during a vacation trip for data which is no longer needed when the trip is concluded, the method may be used to define, in time and space, a navigation corridor within which data is provided which is necessary or useful for the navigation or for a trip. In particular, the area to be defined is not limited to any political boundaries.

1-6. (canceled)

7. A method for enabling useful data, which is one of (a) stored on a data carrier and (b) transmitted into a data processing system, the method comprising:
enabling the useful data for an area which is freely selectable by a user of the useful data.

8. The method according to claim 7, wherein the data includes navigation data.

9. The method according to claim 7, wherein the useful data is enabled for an area within a radius around a freely selectable center point.

10. The method according to claim 7, wherein a use authorization is one of (a) transmitted via a radio signal and (b) present on the data carrier.

11. The method according to claim 8, wherein a navigation system is used to determine whether the user is located within the area for which a use authorization has been granted.

12. The method according to claim 7, wherein enabling takes place in a time-limited manner.

13. The method according to claim 7, wherein the area is not limited to any political boundary.
